(19) United States
(12) Patent Application Publication
(10) Pub. No.: US 2017/0123741 A1
(43) Pub. Date: May 4, 2017

(54) IMAGE FORMING APPARATUS CAPABLE OF MANAGING PRINT JOB AND COMPUTER-READABLE NON-TRANSITORY RECORDING MEDIUM WITH PRINT JOB MANAGEMENT PROGRAM STORED THEREON

(71) Applicant: KYOCERA Document Solutions Inc., Osaka (JP)

(72) Inventors: Efren DURAN, JR., Osaka (JP); RJ Lee DANIEL, Osaka (JP); Anne Marie Isidoree VILLA, Osaka (JP); Shadel Faith ABARQUEZ, Osaka (JP); Jefty NEGAPATAN, Osaka (JP); Ian Kenneth SUNAMURA, Osaka (JP); Carmel GELBOLINGO, Osaka (JP); Paul-Lester SALOMSON, Osaka (JP); Divina AGANG, Osaka (JP); Neil DY, Osaka (JP); Gerald Clyde LABADIA, Osaka (JP); Aubrey Jean ABANES, Osaka (JP); Patrick Ruther DUMILON, Osaka (JP); Tristan Rae C. LISONDRA, Osaka (JP); Warren John CARUANA, Osaka (JP); Jovin JIMENEZ, Osaka (JP)

(73) Assignee: KYOCERA Document Solutions Inc., Osaka (JP)

(21) Appl. No.: 15/331,057

(22) Filed: Oct. 21, 2016

(30) Foreign Application Priority Data
Oct. 30, 2015 (JP) 2015-215244

(51) Int. Cl. G06F 3/12; H04N 1/23

(52) U.S. Cl. CPC G06F 3/1261; H04N 1/2315; G06F 3/1207; G06F 3/1232; G06F 3/1259; G06F 3/1291; H04N 2201/0094; H04N 2201/0039

(57) ABSTRACT

An image forming apparatus includes: a different apparatus detecting section that detects one or more different image forming apparatuses present on a network; an apparatus capability acquisition section that acquires printing capabilities of the different image forming apparatuses; an apparatus selecting section that selects, based on the acquired printing capabilities, at least one different image forming apparatus having a printing capability equivalent to or higher than the present image forming apparatus as an alternative apparatus; a control section that executes a print job; and a print job transfer sections that, when the control section cannot execute the print job, transfers the print job to the alternative apparatus, wherein when the print job transfer section completes the transfer of the print job to the alternative apparatus, the control section allows a display section to display information indicating that the print job has been transferred and a destination for the transfer.

### INCORPORATION BY REFERENCE

This application claims priority to Japanese Patent Application No. 2015-215244 filed on Oct. 30, 2015, the entire contents of which are incorporated by reference herein.

### BACKGROUND

The present disclosure relates to image forming apparatuses capable of managing print jobs and computer-readable non-transitory recording media with a print job management program stored thereon and particularly relates to a technique for surely performing a print job transferred from an information processing apparatus to an image forming apparatus.

In sending a print job from an information processing apparatus to an image forming apparatus and allowing the image forming apparatus to perform the print job, a situation may occur that in the image forming apparatus the print job cannot be completed because, for example, there is no paper sheet of a necessary size for printing indicated in the print job, paper sheets of a necessary type for the printing are not yet contained or it takes a long time to process the print job depending upon the apparatus capability. If this situation occurs, in order to complete the print job, the user needs to cancel the print job from tasks of the present image forming apparatus, find another image forming apparatus capable of executing the print job, and resend the print job from the information processing apparatus to the found other image forming apparatus. To this end, a technique is proposed for, when a print job cannot be executed on an image forming apparatus having received the print job, allowing another alternative printer to execute the print job.

### SUMMARY

A technique improved over the aforementioned technique is proposed as one aspect of the present disclosure.

An image forming apparatus according to an aspect of the present disclosure includes a printing capability storage section, a different apparatus detecting section, an apparatus capability acquisition section, an apparatus selecting section, a communication section, a control section, a print job transfer section, and a display section.

The printing capability storage section stores a printing capability which the present image forming apparatus itself has.

The different apparatus detecting section detects one or more different image forming apparatuses present on a network to which the present image forming apparatus is connected.

The apparatus capability acquisition section acquires, from the one or more different image forming apparatuses detected by the different apparatus detecting section, printing capabilities which the different image forming apparatuses have.

The apparatus selecting section selects, from among the different image forming apparatuses detected by the different apparatus detecting section, at least one different image forming apparatus having a printing capability equivalent to or higher than the printing capability stored in the printing capability storage section as an alternative apparatus based on the printing capabilities acquired by the apparatus capability acquisition section.

The communication section receives a print job from an apparatus present on the network.

The control section executes the print job received by the communication section.

The print job transfer section transfers, when the control section cannot execute the print job, the print job to the alternative apparatus selected by the apparatus selecting section.

Furthermore, when the print job transfer section completes the transfer of the print job to the alternative apparatus, the control section allows the display section to display information indicating that the print job has been transferred and a destination for the transfer.

In a computer-readable non-transitory recording medium with a print job management program stored thereon according to another aspect of the present disclosure, the print job management program allows a computer in an image forming apparatus to function as the above-described printing capability storage section, the above-described different apparatus detecting section, the above-described apparatus capability acquisition section, the above-described apparatus selecting section, the above-described communication section, the above-described control section, and the above-described print job transfer section.

### BRIEF DESCRIPTION OF THE DRAWINGS

FIG. 1 is a schematic diagram of an image forming system according to a first embodiment of the present disclosure.

FIG. 2 is a functional block diagram schematically showing an essential internal configuration of an information processing apparatus.

FIG. 3 is a functional block diagram schematically showing an essential internal configuration of the image forming apparatus.

FIG. 4 is a flowchart showing processing for detecting alternative apparatuses in the image forming apparatus.

FIG. 5 is a view showing an example of a display screen displayed on a display section.

FIG. 6 is a view showing another example of a display screen displayed on the display section.

FIG. 7 is a view showing still another example of a display screen displayed on the display section.

FIG. 8 is a view showing still another example of a display screen displayed on the display section.

FIG. 9 is a view showing still another example of a display screen displayed on the display section.

FIG. 10 is a view showing still another example of a display screen displayed on the display section.

FIG. 11 is a flowchart showing processing for transferring a print job in the image forming apparatus.

FIG. 12 is a view showing still another example of a display screen displayed on the display section.

FIG. 13 is a view showing still another example of a display screen displayed on the display section.

### DETAILED DESCRIPTION

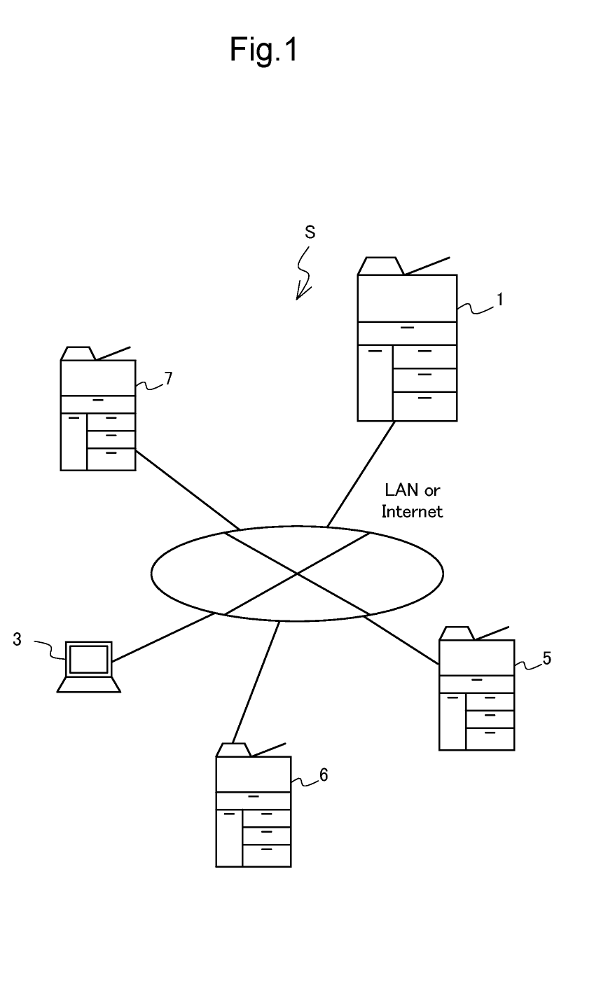

Hereinafter, a description will be given of an image forming apparatus, a print job management program, an image forming system, a method for managing a print job, and a computer-readable non-transitory recording medium with the print job management program stored thereon, all according to an embodiment as an aspect of the present disclosure, with reference to the drawings. FIG. 1 is a schematic diagram of an image forming system according to a first embodiment of the present disclosure.

As shown in FIG. 1, an information processing apparatus and a plurality of image forming apparatuses, including an information processing apparatus 3 and image forming apparatuses 1, 5 to 7, are connected via a LAN (local area network) to each other. Each of the plurality of image forming apparatuses has at least a print function. The information processing apparatus and the image forming apparatuses have a communication function and are thus capable of being communicated with each other via the LAN or the like.

In this embodiment, among the plurality of image forming apparatuses, the image forming apparatus 1 is an image forming apparatus according to one embodiment of the present disclosure. The other image forming apparatuses 5 to 7 are general image forming apparatuses not according to embodiments of the present disclosure.

An image forming system S according to one embodiment of the present disclosure is made up by including a plurality of image forming apparatuses and an information processing apparatus, all according to one embodiment of the present disclosure.

The plurality of image forming apparatuses have different printing capabilities. The printing capability is print information, including printable sheet sizes, a printable color (multicolor or black-and-white), single-sided/double-sided printability, a printing speed (sheets/min), and a location of installation of the image forming apparatus. The print information preferably contains at least printable sheet sizes, a printable color, and single-sided/double-sided printability.

The information processing apparatus 3 is, for example, a personal computer and is capable of being communicated with the plurality of image forming apparatuses via the LAN or the like. The information processing apparatus 3 has a printer driver function for the image forming apparatus 1. The information processing apparatus 3 has, through the printer driver function, for example, the function of sending a print job to at least the image forming apparatus 1 and giving an instruction to perform printing to the image forming apparatus 1.

On the other hand, the image forming apparatus 1 detects, for example, through the Bonjour function, different image forming apparatuses connected via the LAN to the image forming apparatus 1. Furthermore, the image forming apparatus 1 requests the detected image forming apparatuses to send information indicating their printing capabilities and receives the information indicating the printing capabilities from the detected image forming apparatuses.

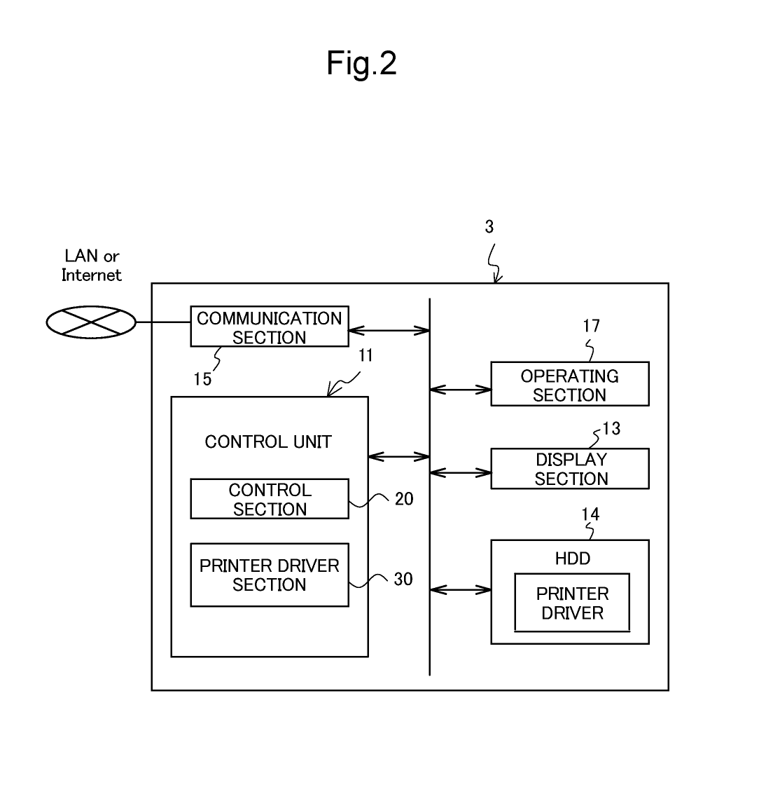

FIG. 2 is a functional block diagram schematically showing an essential internal configuration of the information processing apparatus 3. The information processing apparatus 3 is made up by including a control unit 11, an operating section 17, a display section 13, an HDD (hard disk drive) 14, and a communication section 15.

The control unit 11 is composed of a CPU (central processing unit), a RAM (random access memory), a ROM (read only memory), a dedicated hardware circuit, and so on. The control unit 11 includes a control section 20 and operates according to a printer driver stored on the HDD 14 to function also as a printer driver section 30.

The control section 20 governs the overall operation control of the information processing apparatus 3, is connected to the operating section 17, the display section 13, the HDD 14, and the communication section 15, and controls these components.

The operating section 17 is formed of a keyboard, a mouse or the like, through which a print instruction for sending a print job to the individual image forming apparatus 1 can be input by the operation of a user as an operator. According to the print instruction input through the operating section 17, the control section 20 allows the communication section 15 to send the print job to the individual image forming apparatus 1.

The display section 13 include, for example, an LCD (liquid crystal display) or the like and displays various types of operation guidance and messages for the user. The HDD 14 stores data, such as programs and a printer driver, necessary for the operation of the information processing apparatus 3.

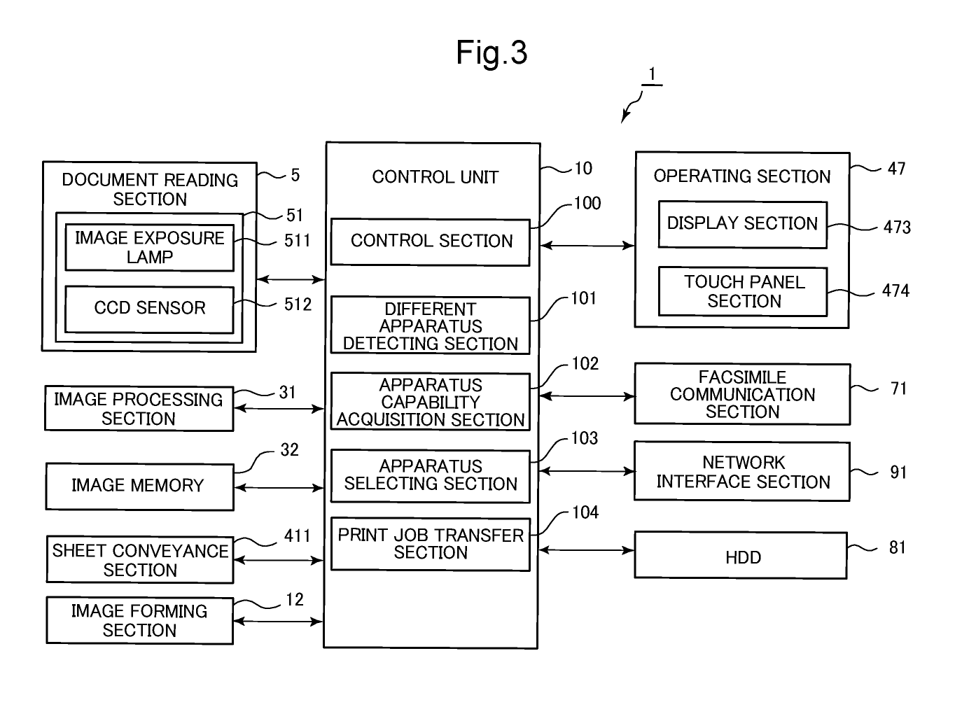

Next, a description will be given of the image forming apparatus 1 according to the one embodiment of the present disclosure with reference to the drawings. FIG. 3 is a functional block diagram schematically showing an essential internal configuration of the image forming apparatus 1.

The image forming apparatus 1 includes a control unit 10. The control unit 10 is composed of a CPU, a RAM, a ROM, a dedicated hardware circuit, and so on. The ROM is, for example, a non-volatile ROM and stores the printing capability which the image forming apparatus 1 has, for example, print information including printable sheet sizes, a printable color (multicolor or black-and-white), single-sided/double-sided printability, a printing speed (sheets/min), and so on. The ROM is an example of the printing capability storage section defined in What is claimed is.

The control unit 10 (an example of the computer in the image forming apparatus in What is claimed is) is connected to a document reading section 5, an image processing section 31, an image memory 32, a sheet conveyance section 411, an image forming section 12, an operating section 47 (an example of the instruction input section), a facsimile communication section 71, a network interface section 91 (an example of the communication section), an HDD 81, and so on. The control unit 10 performs the operation control of the above components connected thereto and signal or data transfer to and from the components.

The document reading section 5 includes a scanner section 51 formed of a reader which includes: an image exposure lamp 511 and a CCD (charge coupled device) sensor 512. The document reading section 5 reads an image from an original document by applying light to the original document with the image exposure lamp 511 and receiving, at the CCD sensor 512, reflected light from the original document.

The image processing section 31, if necessary, processes image data of the image read by the document reading section 5. The image memory 32 stores image data read by the document reading section 5 or other data.

The image forming section 12 includes image forming units for different colors for forming a multicolor image, an intermediate transfer belt which travels in an endless path at a location facing the image forming units for different colors so that toner images are transferred thereto from the image forming units, and a secondary transfer roller that transfers the toner images from the intermediate transfer belt to a recording paper sheet. The image data subject to image formation by the image forming section 12 is, for example, image data transmitted via the network interface section 91 from the information processing apparatus 3 in the LAN.

The operating section 47 includes a touch panel section 474 and an operating key section which accept user's instructions for various types of operations and processing executable on the image forming apparatus 1. The touch panel section 474 is provided on a display of a display section 473 included in the operating section 47.

The facsimile communication section 71 includes a coding/decoding section, a modulation/demodulation section, and an NCU (network control unit), all of which are not illustrated, and performs facsimile communication using a public telephone network.

The HDD 81 is capable of storing image data read by the document reading section 5 or other data.

The network interface section 91 is constituted by a communication module, such as a LAN board, and transfers various data to and from the information processing apparatus 3, the image forming apparatuses 5 to 7, and so on in the local area via the LAN or the like connected to the network interface section 91.

The control unit 10 includes a control section 100 that governs the overall operation control of the above-described image forming apparatus 1. The control section 100 controls the driving and processing of each of the above components necessary to perform the operation control of each of the scan function, the print function, the copy function, and the facsimile function according to an instruction to execute a job entered by the user's operation of the operating section 47 or a job entered from the network-connected information processing apparatus 3 or the like.

The control unit 10 further includes a different apparatus detecting section 101, an apparatus capability acquisition section 102, an apparatus selecting section 103, and a print job transfer section 104. When the CPU of the control unit 10 operates in accordance with a print job management program according to one embodiment of the present disclosure stored in the memory or ROM included in the control unit 10 or the HDD 81, the memory region in the control unit 10 serves as the printing capability storage section and the control unit 10 also functions as the different apparatus detecting section 101, the apparatus capability acquisition section 102, the apparatus selecting section 103, and the print job transfer section 104. Alternatively, the control unit 10 may include the different apparatus detecting section 101, the apparatus capability acquisition section 102, the apparatus selecting section 103, and the print job transfer section 104 by including dedicated hardware circuits corresponding to the above ROM as the printing capability storage section, the different apparatus detecting section 101, the apparatus capability acquisition section 102, the apparatus selecting section 103, and the print job transfer section 104.

The different apparatus detecting section 101 detects one or more different image forming apparatuses present on a network to which the image forming apparatus 1 is connected. The different apparatus detecting section 101 detects, for example, through the Bonjour function, the image forming apparatuses 5 to 7 on the LAN.

The apparatus capability acquisition section 102 acquires, from each of the plurality of image forming apparatuses detected by the different apparatus detecting section 101, the printing capability which the individual image forming apparatus has.

The apparatus selecting section 103 selects, from among the detected different image forming apparatuses, at least one different image forming apparatus having a printing capability equivalent to or higher than the printing capability stored in the above ROM serving as the printing capability storage section as an alternative apparatus based on the printing capabilities acquired by the apparatus capability acquisition section 102.

For example, the apparatus selecting section 103 analyses each of the respective printing capabilities of the plurality of image forming apparatuses acquired by the apparatus capability acquisition section 102. The apparatus selecting section 103 compares each of the printing capabilities which the individual image forming apparatuses have, i.e., printing capability items including printable sheet sizes, a printable color (multicolor or black-and-white), single-sided/double-sided printability, and a printing speed (sheets/min) in this embodiment, with the items indicated by the printing capability of the image forming apparatus 1 stored in the above ROM and selects at least one image forming apparatus having all printing capability items equivalent to or higher than those of the image forming apparatus 1 stored in the ROM as an alternative apparatus. The above printing capability is sufficient if it includes the above-described printable sheet sizes, printable color (multicolor or black-and-white), single-sided/double-sided printability, and printing speed (sheets/min), but the description in this embodiment will be given of an example where the printing capability further includes information on the location of installation.

For example, if the printable sheet sizes indicated in the printing capability of the image forming apparatus 1 stored in the ROM are A4 and A3 and the printable sheet sizes indicated in the printing capability of a different image forming apparatus detected by the different apparatus detecting section 101 are A4, A3, B4, and B5, the apparatus selecting section 103 determines that the printing capability of the different image forming apparatus is equivalent or higher in this item. Unlike the above, if the printable sheet sizes indicated in the printing capability of the image forming apparatus 1 stored in the ROM are A4, A3, B4, and B5 and the printable sheet sizes indicated in the printing capability of a different image forming apparatus detected by the different apparatus detecting section 101 are B4 and B5, the apparatus selecting section 103 determines that the printing capability of the different image forming apparatus is neither equivalent nor higher in this item.

When the control section 100 cannot execute a print job which it has received from the information processing apparatus 3, the print job transfer section 104 transfers the print job to the alternative apparatus selected by the apparatus selecting section 103. The print job transfer section 104 may transfer the received print job itself to the alternative apparatus or may transfer print data converted into a data form printable on the alternative apparatus as a print job to the alternative apparatus.

Alternatively, when the control section 100 cannot execute the print job which it has received from the information processing apparatus 3, the print job transfer section 104 may transfer the print job to an alternative apparatus selected by the apparatus selecting section 103, only if it determines as follows.

For example, every time each of alternative apparatuses selected by the apparatus selecting section 103 changes its printing capability, the apparatus capability acquisition section 102 acquires print information indicating a new printing capability from the alternative apparatus. Then, when the control section 100 cannot execute the print job, the print job transfer section 104 compares the printing capability necessary to execute the print job with the new printing capabilities of the selected alternative apparatuses acquired by the apparatus capability acquisition section 102, determines, from among the above alternative apparatuses, an image forming apparatus having a new printing capability enough to execute the print job as an alternative apparatus which is a destination to transfer the print job, and transfers the print job to this alternative apparatus.

For example, even an alternative apparatus selected by the apparatus selecting section 103 and having a printing capability equivalent to or higher than that of the image forming apparatus 1 may become less able to execute the print job after having been selected as an alternative apparatus, because of, for example, out of paper, out of toner or apparatus failure. Therefore, periodically or at least when it is determined that the control section 100 cannot execute the print job, the apparatus capability acquisition section 102 requests the alternative apparatuses to send information indicating their printing capabilities and acquires from the alternative apparatuses information indicating the latest apparatus statuses, such as out of paper, out of toner or apparatus failure, as the new printing capabilities.

Then, based on the new printing capabilities of the alternative apparatuses, the print job transfer section 104 determines, for example, whether each alternative apparatus contains paper sheets of a size necessary to execute the print job, whether each alternative apparatus secures an amount of toner enough for printing, and whether each alternative apparatus is not in failure, thus determining an image forming apparatus having an apparatus status satisfying all the conditions enabling the execution of the print job as an alternative apparatus capable of executing the print job, and transfers the print job inexecutable by the image forming apparatus 1 to the determined alternative apparatus.

In this manner, an alternative apparatus capable of executing the print job at the time when the print job is required to be executed is appropriately extracted and the print job is transferred from the image forming apparatus 1 to the alternative apparatus, thus increasing the possibility of completing the execution of the print job.

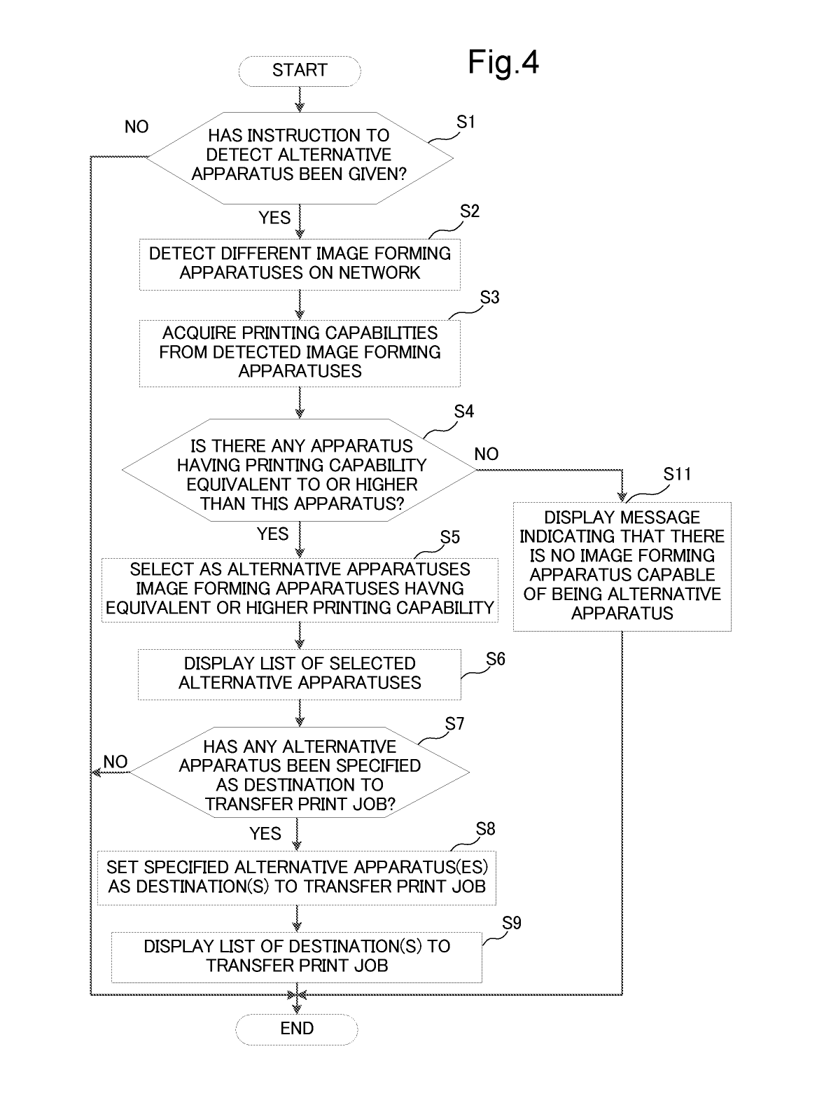

Next, a description will be given of processing for detecting alternative apparatuses in the image forming apparatus 1. FIG. 4 is a flowchart showing the processing for detecting alternative apparatuses in the image forming apparatus 1.

When setting an alternative apparatus for the image forming apparatus 1, the user operates the operating section 47 of the image forming apparatus 1 to input an instruction to detect an alternative apparatus (S1). The alternative apparatus refers to an image forming apparatus that, when the present image forming apparatus 1 cannot execute a print job received from the information processing apparatus 3, serves as a destination to transfer the print job from the image forming apparatus 1.

When the different apparatus detecting section 101 detects that the above instruction to detect an alternative apparatus has been input from the user (YES in S1), it detects, through the Bonjour function using, for example, SNMP, one or more different image forming apparatuses present on the network to which the image forming apparatus 1 is connected (S2).

Subsequently, the apparatus capability acquisition section 102 acquires, from each of the different image forming apparatuses detected in S2, the printing capability which the individual image forming apparatus has (S3).

Next, the apparatus selecting section 103 determines, based on items, including printable sheet sizes, a printable color (multicolor or black-and-white), single-sided/double-sided printability, and a printing speed (sheets/min), indicated in the acquired printing capability of each of the different image forming apparatuses, whether or not there is any different image forming apparatus having a printing capability equivalent to or higher than that of the image forming apparatus 1 stored in the ROM which is the printing capability storage section (S4).

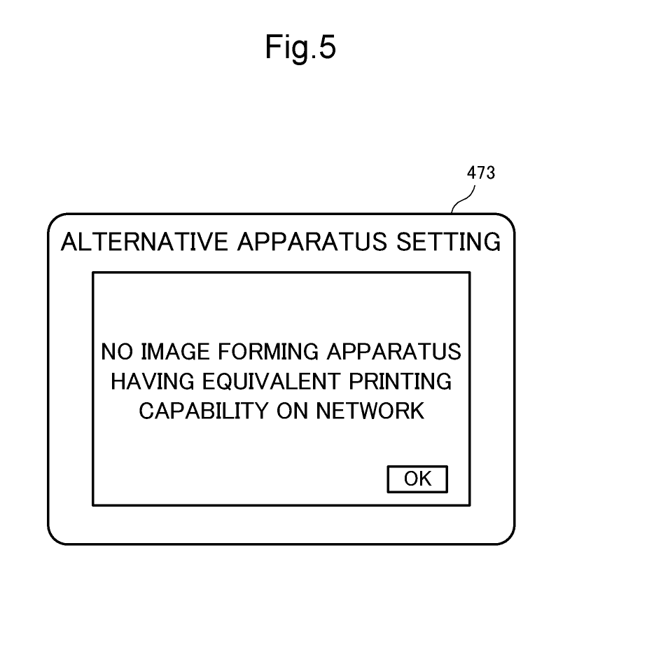

If the apparatus selecting section 103 determines that no image forming apparatus having a printing capability equivalent to or higher than that of the image forming apparatus 1 exists (NO in S4), the control section 100 allows the display section 473 to display a display screen (shown as an example in FIG. 5) indicating that no image forming apparatus capable of being an alternative apparatus exists on the network (S11). Thereafter, the processing ends.

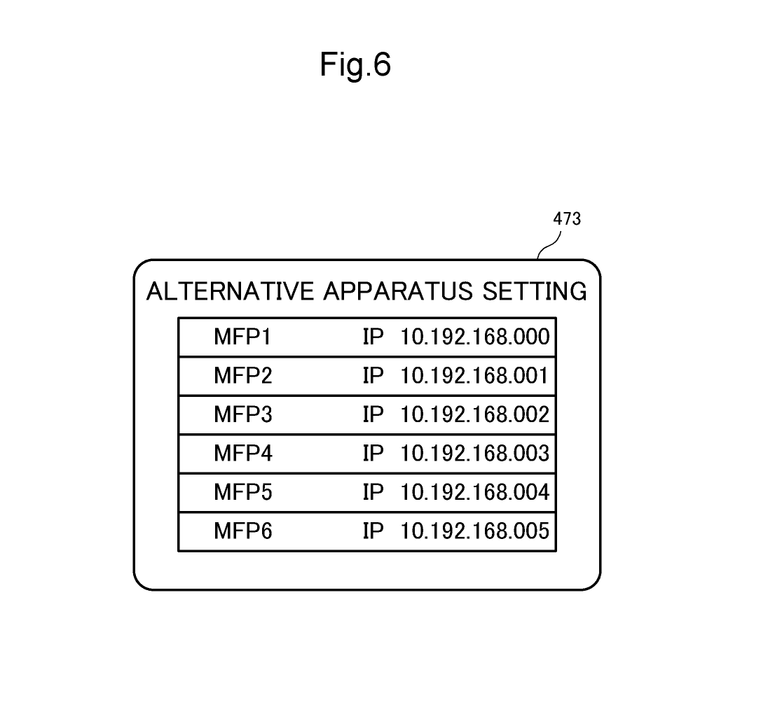

On the other hand, if the apparatus selecting section 103 determines that one or more different image forming apparatuses having a printing capability equivalent to or higher than that of the image forming apparatus 1 exist (YES in S4), it selects the different image forming apparatuses having such a printing capability as alternative apparatuses (S5). The control section 100 allows the display section 473 to display a list of the selected alternative apparatuses as shown as an example in FIG. 6 (S6).

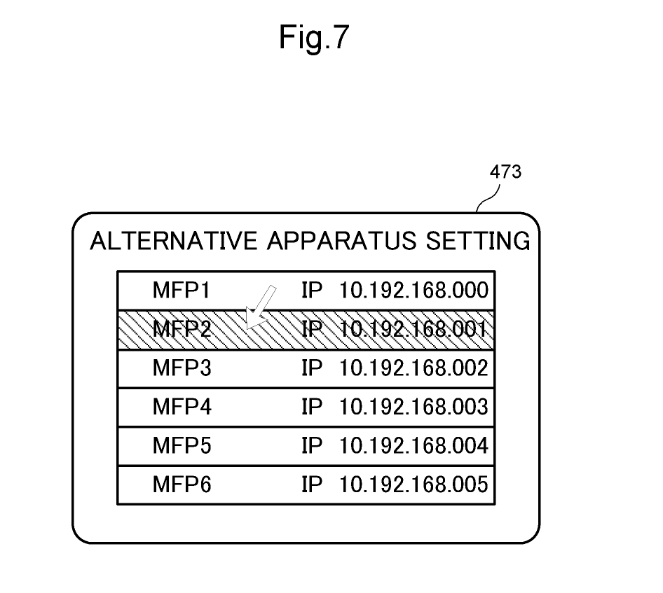

When during display of the list an instruction to specify, from among the displayed alternative apparatuses, an apparatus to be set as a destination to transfer the print job is input through the user's operation of the operating section 47 with a user's touch on a region of the display screen of the display section 473 where the apparatus is displayed and by a touch panel function, for example, as shown in FIG. 7 (YES in S7), the control section 100 allows the display section 473 to display, based on the information on the location of installation contained in the printing capability of the specified image forming apparatus, the location of installation of the image forming apparatus.

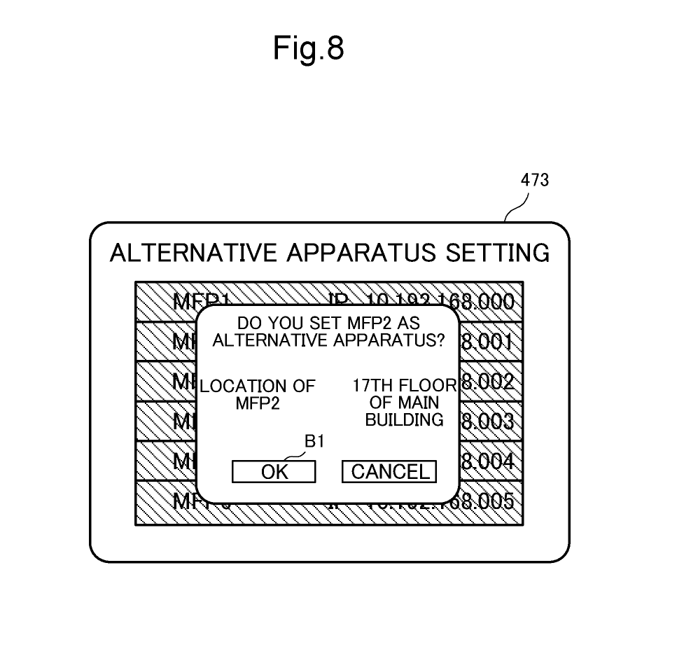

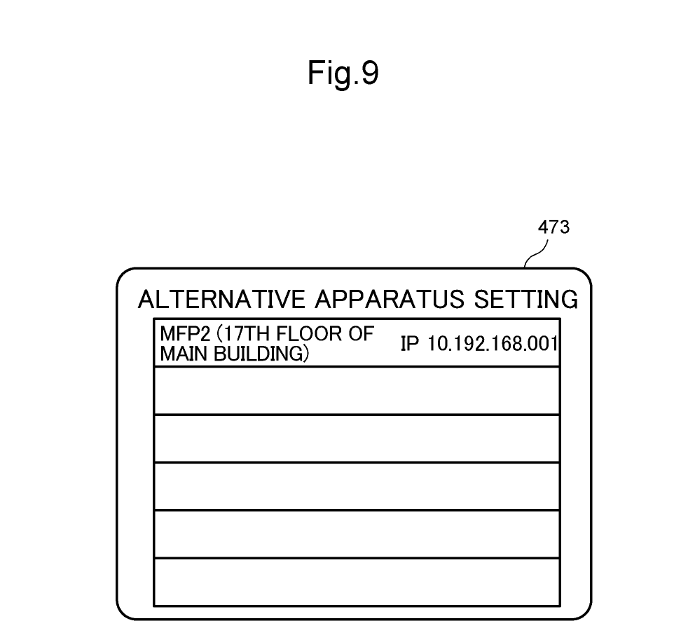

When in this situation an OK button B1 as shown in FIG. 8 is pressed by a user's touch gesture on the display screen, an instruction to determine the specification of the image forming apparatus is input to the operating section 47 by the touch panel function and the apparatus selecting section 103 sets, according to this instruction, the specified apparatus as an alternative apparatus which is a destination to transfer the print job (S8). The control section 100 allows the display section 473 to display a list of the alternative apparatus as a destination to transfer the print job as shown as an example in FIG. 9 (S9). If NO in S1 and NO in S7, the processing ends.

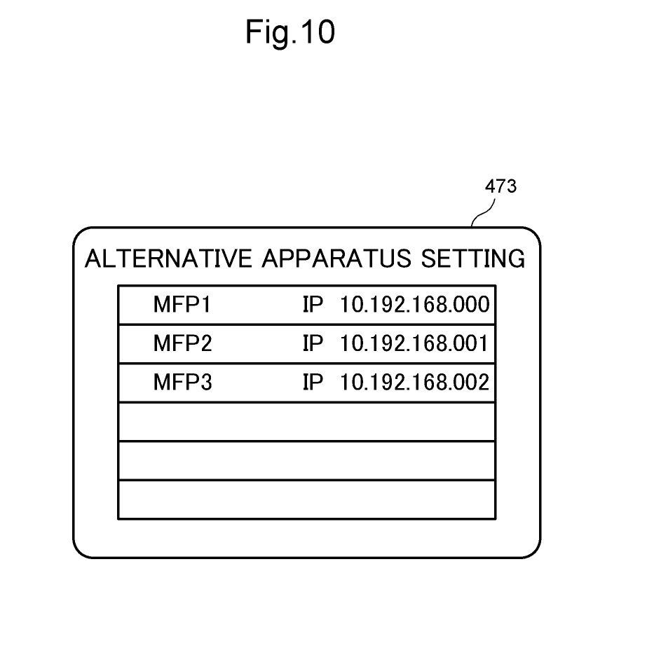

In S7, the apparatus selecting section 103 may accept a user's entry of an instruction to specify a plurality of alternative apparatuses to be set as destinations to transfer the print job. In this case, the control section 100 sets the plurality of specified alternative apparatuses as destinations to transfer the print job and allows the display section 473 to display the plurality of alternative apparatuses as destinations to transfer the print job as shown as an example in FIG. 10.

Furthermore, the apparatus selecting section 103 may accept a user's instruction to delete one or more alternative apparatuses already set as destinations to transfer the print job by the specification of these apparatuses with touch gestures and by the touch panel function and may cancel the setting of the specified apparatuses as the destinations to transfer the print job. In this case, the control section 100 allows the above alternative apparatuses the setting of which as destinations to transfer the print job has been cancelled to disappear from the display screen indicating alternative apparatuses as destinations to transfer the print job.

In this relation, when the apparatus selecting section 103 accepts the above user's instruction to delete the alternative apparatuses, the control section 100 allows the display section 473 to display, based on the information on the locations of installation contained in the printing capabilities of the image forming apparatuses specified to be deleted, the locations of installation of the image forming apparatuses in the same manner as described with reference to FIG. 8. Then, if an instruction to determine the specification of the image forming apparatuses to be deleted is input to the operating section 47 by the user, the apparatus selecting section 103 may delete the image forming apparatuses specified to be deleted in the above manner from the list of destinations to transfer the print job.

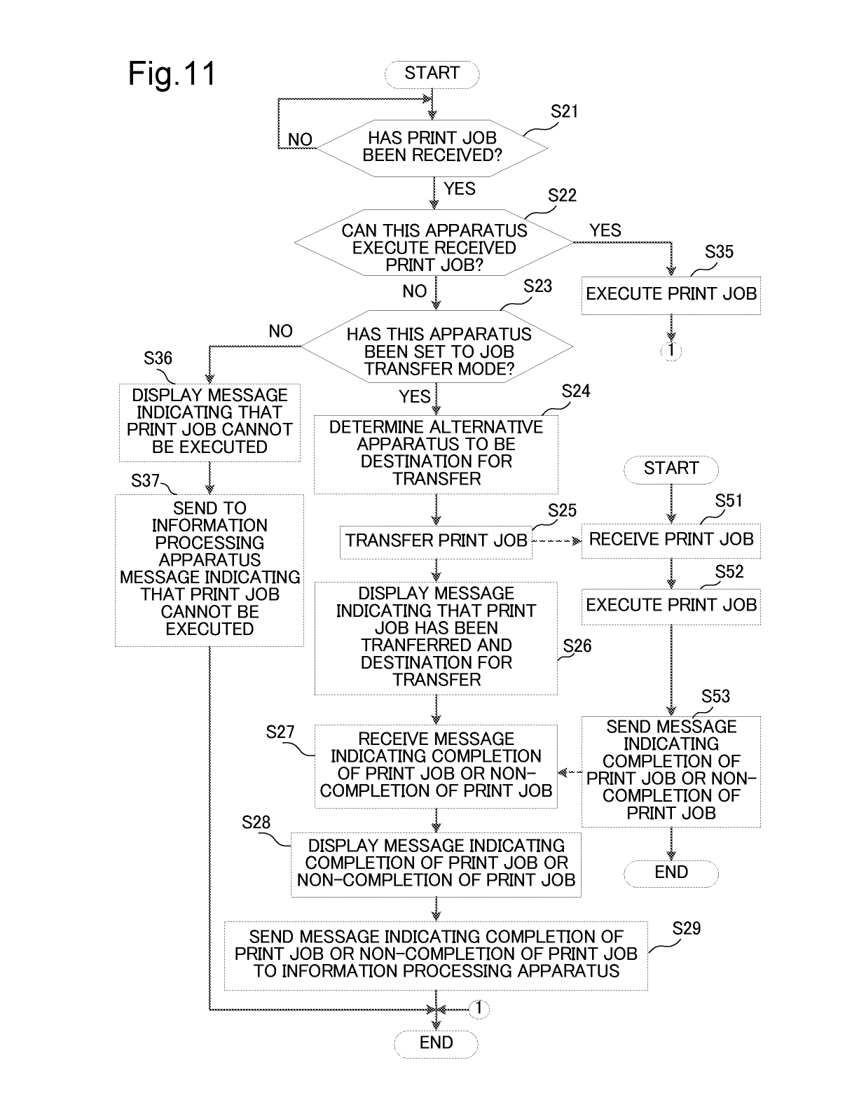

Next, a description will be given of processing for transferring a print job in the image forming apparatus 1. FIG. 11 is a flowchart showing the processing for transferring a print job in the image forming apparatus 1.

When the user operates the operating section 17 of the information processing apparatus 3 to send a print job to the image forming apparatus 1 and the image forming apparatus 1 receives the print job via the network interface section 91 (YES in S21), the control section 100 determines whether or not the image forming apparatus 1 can execute the print job (S22). For example, if a comparison made by the control section 100 between a printing capability necessary to execute the print job and the printing capability of the image forming apparatus 1 stored in the ROM shows that the image forming apparatus 1 has the printing capability necessary to execute the print job, the control section 100 determines that the print job can be executed by the image forming apparatus 1 (YES in S22). In this case, the control section 100 executes the print job to allow the image forming section 12 to perform image formation on a necessary number of recording paper sheets based on print target data contained in the print job (S35).

For example, if the printing capability of the image forming apparatus 1 includes printable sheet sizes of A4, A3, B4, and B5, a printable color of black-and-white, and single-sided and double-sided printability and the printing capability necessary to execute the print job is constituted by a printable sheet size of A4, a printable color of black-and-white, and single-sided printability, the control section 100 determines that the print job can be executed by the image forming apparatus 1.

For another example, if the printing capability of the image forming apparatus 1 is the same as described above and the printing capability necessary to execute the print job is constituted by a printable sheet size of A4, multicolor printability, and single-sided printability, multicolor printing cannot be performed by the image forming apparatus 1. Therefore, the control section 100 determines that the print job cannot be executed by the image forming apparatus 1.

On the other hand, when the image forming apparatus 1 does not have the printing capability necessary to execute the print job, so that the control section 100 determines that the print job cannot be executed by the image forming apparatus 1 (NO in S22), the print job transfer section 104 determines whether or not the mode of the image forming apparatus 1 set by the control section 100 is a job transfer mode (S23).

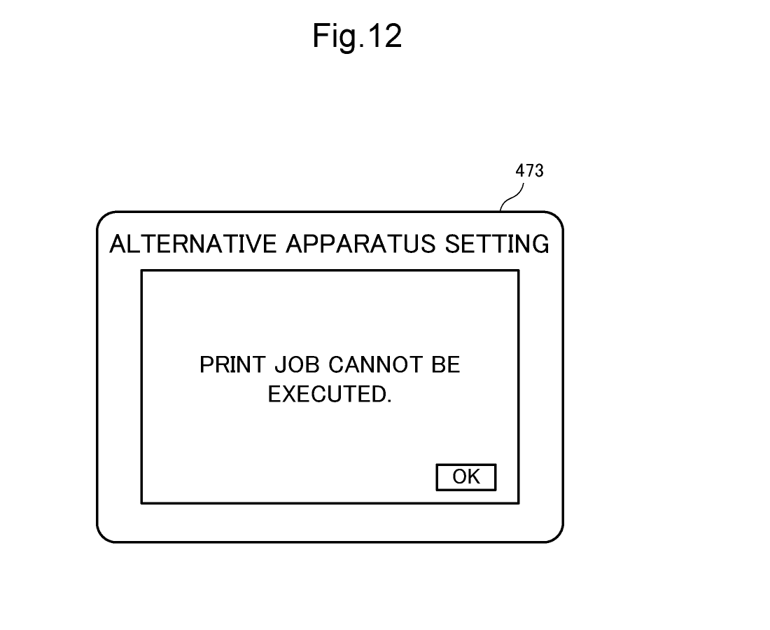

If the print job transfer section 104 determines that the mode of the image forming apparatus 1 is not the job transfer mode (NO in S23), the control section 100 allows the display section 473 to display a message indicating that the print job cannot be executed as shown as an example in FIG. 12 (S36). Thereafter, the control section 100 sends information indicating that the print job cannot be executed to the information processing apparatus 3 having sent the print job (S37). When the information processing apparatus 3 receives this information, its control section 20 allows the display section 13 to display, based on the information, the message indicating that the print job cannot be executed.

If in S23 the print job transfer section 104 determines that the mode of the image forming apparatus 1 is the job transfer mode (YES in S23), the print job transfer section 104 further determines, from among one or more alternative apparatuses selected by the apparatus selecting section 103, an alternative apparatus to be a destination to transfer the print job inexecutable by the image forming apparatus 1 (S24). At this time, if a single alternative apparatus has been selected by the apparatus selecting section 103, the print job transfer section 104 determines this alternative apparatus as the destination to transfer the print job. On the other hand, if a plurality of alternative apparatuses have been selected by the apparatus selecting section 103, the print job transfer section 104 determines, based on the printing capabilities of the alternative apparatuses, (1) an image forming apparatus having the highest printing speed or (2) an image forming apparatus disposed closest to the information processing apparatus 3 having sent the print job as the destination to transfer the print job.

In place of or in addition to this determination method, if the apparatus capability acquisition section 102 has acquired information indicating the latest apparatus statuses, such as out of paper, out of toner or apparatus failure, as the above-described new printing capabilities from the different image forming apparatuses detected by the different apparatus detecting section 101, the print job transfer section 104 may determine, based on the new printing capabilities of the different image forming apparatuses, for example, whether each image forming apparatus contains paper sheets of a size necessary to execute the print job, whether each image forming apparatus secures an amount of toner enough for printing, and whether each image forming apparatus is not in failure, and thus determine an image forming apparatus having an apparatus status satisfying all the conditions enabling the execution of the print job as an alternative apparatus which is a destination to transfer the print job.

When determining an alternative apparatus serving as a destination to transfer the print job in the above manner, the print job transfer section 104 transfers the print job via the network interface section 91 to the determined alternative apparatus (S25).

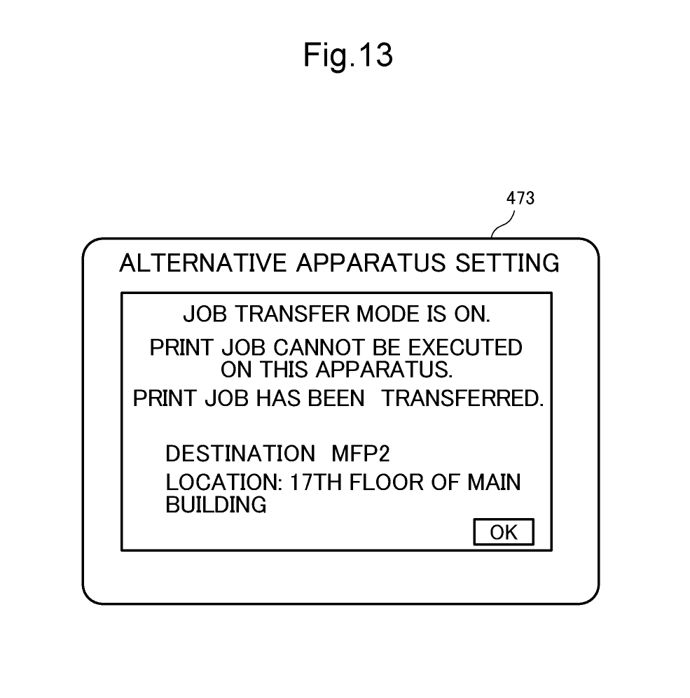

Then, the control section 100 allows the display section 473 to display information indicating that the print job has been transferred and indicating the alternative apparatus as the destination to transfer the print job in a manner shown as an example in FIG. 13 (S26).

When the alternative apparatus determined as the destination receives the print job by the transfer processing of the print job transfer section 104 of the image forming apparatus 1 (S51), the control section of the alternative apparatus executes the print job to allow the image forming section to perform image formation of the print target data indicated in the print job (S52). Then, the alternative apparatus sends to the image forming apparatus 1 the following information: if the print job could be completed, completion information indicating this; or if the print job could not be completed, non-completion information indicating this (S53).

When in the image forming apparatus 1 the network interface section 91 receives the completion information or the non-completion information (S27), the control section 100 allows the display section 473 to display, according to the contents of the received information, either the fact that the print job could be completed or the fact that the print job could not be completed (S28).

Furthermore, the control section 100 sends the following information via the network interface section 91 to the information processing apparatus 3 having sent the print job: if it has received the completion information, information indicating that the print job could be completed; or if it has received the non-completion information, information indicating that the print job could not be completed (S29).

In addition, when the control section 100 receives the non-completion information from the alternative apparatus, the processing may go back to S24 and the print job transfer section 104 may repeat the processing in S24 and later steps in order to redetermine, from among the alternative apparatuses selected by the apparatus selecting section 103, an alternative apparatus different from the previously determined alternative apparatus as a destination to transfer the print job under the same conditions of selection as above. Thus, the print job having been sent from the information processing apparatus 3 to the image forming apparatus 1 can be more securely completed by the different image forming apparatus.

According to this embodiment, when the image forming apparatus 1 having been requested to execute a print job from the information processing apparatus 3 could not execute the print job and transferred the print job to a different image forming apparatus, for example, one of the image forming apparatuses 5 to 7, the user can know, from the image forming apparatus 1, the fact that the print job has been transferred to the different image forming apparatus, even after the user has departed from the information processing apparatus 3 having sent the print job and has come to the image forming apparatus 1.

For example, in the technique described in BACKGROUND, after a user has sent a print job from an information processing apparatus to a first image forming apparatus, the first image forming apparatus does not notify the user of any information on the print job regardless of whether or not it has transferred the print job to an alternative printer. Therefore, there arises a problem that even if the user comes to the first image forming apparatus in order to collect prints, the user cannot know, from the image forming apparatus, that the image forming apparatus has failed to execute the print job, that the print job is merely taking a long time to process or that the print job has been transferred to another printer. According to the above embodiment, this problem does not arise.

The present disclosure is not limited to the configuration of the above embodiment and can be modified in various ways. For example, although the description of the above embodiment is given taking a multifunction peripheral as an example of the image forming apparatus according to the present disclosure, the example is merely illustrative and the image forming apparatus may be any other image forming apparatus, such as a printer or a copier.

Furthermore, the structure, configuration, and processing described in the above embodiment with reference to FIGS. 1 to 13 are merely illustrative and are not intended to limit the present disclosure to them.

Various modifications and alterations of this disclosure will be apparent to those skilled in the art without departing from the scope and spirit of this disclosure, and it should be understood that this disclosure is not limited to the illustrative embodiments set forth herein.

What is claimed is:

1. An image forming apparatus comprising:
a printing capability storage section that stores a printing capability which the present image forming apparatus itself has;
a different apparatus detecting section that detects one or more different image forming apparatuses present on a network to which the present image forming apparatus is connected;
an apparatus capability acquisition section that acquires, from the one or more different image forming apparatuses detected by the different apparatus detecting section, printing capabilities which the different image forming apparatuses have;
an apparatus selecting section that selects, from among the different image forming apparatuses detected by the different apparatus detecting section, at least one different image forming apparatus having a printing capability equivalent to or higher than the printing capability stored in the printing capability storage section as an alternative apparatus based on the printing capabilities acquired by the apparatus capability acquisition section;
a communication section that receives a print job from an apparatus present on the network;
a control section that executes the print job received by the communication section;
a print job transfer section that, when the control section cannot execute the print job, transfers the print job to the alternative apparatus selected by the apparatus selecting section; and
a display section,
wherein when the print job transfer section completes the transfer of the print job to the alternative apparatus, the control section allows the display section to display information indicating that the print job has been transferred and a destination for the transfer.

2. The image forming apparatus according to claim 1, wherein
the apparatus capability acquisition section periodically acquires information indicating new printing capabilities from the selected alternative apparatuses, and
when the control section cannot execute the print job, the print job transfer section compares a printing capability necessary to execute the print job with the new printing capabilities acquired by the apparatus capability acquisition section and determines, from among the alternative apparatuses, the alternative apparatus having the printing capability enough to execute the print job as a destination to transfer the print job.

3. The image forming apparatus according to claim 1, wherein when the alternative apparatus completes the execution of the print job, the control section allows the display section to display information indicating that the print job has been completed.

4. The image forming apparatus according to claim 1, further comprising an instruction input section to which an instruction from a user is input, wherein
the apparatus selecting section allows the display section to display information indicating the detected different image forming apparatuses and,
when an apparatus specifying instruction specifying one or more of the displayed different image forming apparatuses is input to the instruction input section, the apparatus selecting section sets the one or more image forming apparatuses indicated by the apparatus specifying instruction as the alternative apparatuses.

5. The image forming apparatus according to claim 4, wherein when the plurality of alternative apparatuses are set by the apparatus specifying instruction, the apparatus selecting section selects, as the alternative apparatus to which the print job is to be transferred, the different image forming apparatus disposed closest to the apparatus having sent the print job to the present image forming apparatus or the different image forming apparatus having the highest printing speed.

6. The image forming apparatus according to claim 1, wherein
the apparatus capability acquisition section acquires, as the printing capability, print information including at least a printable sheet size, a printable color, and single-sided/double-sided printability from the different image forming apparatuses, and
the apparatus selecting section selects as the alternative apparatus the different image forming apparatus having a printable sheet size, a printable color, and single-sided/double-sided printability which are necessary for printing indicated in the print job.

7. The image forming apparatus according to claim 1, wherein when the print job transfer section completes the transfer of the print job to the alternative apparatus, the communication section sends, to the apparatus having sent the print job, information indicating that the print job has been transferred and the destination for the transfer.

8. The image forming apparatus according to claim 1, wherein when the alternative apparatus serving as the destination to transfer the print job completes the execution of the print job, the communication section sends, to the apparatus having sent the print job, information indicating that the execution of the print job has been completed.

9. A computer-readable non-transitory recording medium with a print job management program stored thereon, the print job management program allowing a computer in an image forming apparatus to function as:
a printing capability storage section that stores a printing capability which the present image forming apparatus itself has;
a different apparatus detecting section that detects one or more different image forming apparatuses present on a network to which the present image forming apparatus is connected;
an apparatus capability acquisition section that acquires, from the one or more different image forming apparatuses detected by the different apparatus detecting section, printing capabilities which the different image forming apparatuses have;
an apparatus selecting section that selects, from among the different image forming apparatuses detected by the different apparatus detecting section, at least one different image forming apparatus having a printing capability equivalent to or higher than the printing capability stored in the printing capability storage section as an alternative apparatus based on the printing capabilities acquired by the apparatus capability acquisition section;
a communication section that receives a print job from an apparatus present on the network;
a control section that executes the print job received by the communication section; and
a print job transfer section that, when the control section cannot execute the print job, transfers the print job to the alternative apparatus selected by the apparatus selecting section,
wherein when the print job transfer section completes the transfer of the print job to the alternative apparatus, the control section allows the computer to further function to allow the display section to display information indicating that the print job has been transferred and a destination for the transfer.
